(19) United States
(12) Patent Application Publication
(10) Pub. No.: US 2006/0136733 A1
(43) Pub. Date: Jun. 22, 2006

(54) Anti-pirating system

(76) Inventor: Mark E. Ogram, Tucson, AZ (US)

Correspondence Address: Mark E. Ogram, 7454 E. Broadway ste 203, Tucson, AZ, 85710, US

(21) Appl. No.: 11/013,825

(22) Filed: Dec. 16, 2004

(51) Int. Cl. H04L 9/00

(52) U.S. Cl. 713/182

(57) ABSTRACT

A software distribution system which uses a removable medium for distribution of software programs. In the preferred embodiment, a primary software program and a secondary software program are used. The secondary software program is used to establish an identifier and then to erase the secondary software program from all files. This identifier is used by the primary software program to assure it is running on the proper computer; if the identifier is not there, then the software program terminates. In alternative embodiments, the identifier is established using a downloaded secondary software program or by a download of the identifier from the manufacturer of the primary software program. In some embodiments, the identifier is stored on a removable medium, thereby forming a “key” which used when the primary software is to be operated.

### BACKGROUND OF THE INVENTION

This invention relates generally to software and more particularly to systems which restrict the unauthorized copying of software.

“Pirating” of software is the un-licensed use of the software. In some countries, it has been estimated that in the range of 60-85% of all software is a “pirated” copy. Obviously, each un-licensed or pirated copy of a software program takes money away from the developer of the software; this often runs into the billions of dollars.

The creation of pirated copies is typically done through one of two different techniques. The first technique is that a single authorized or licensed copy is purchased and that diskette is shared with many other unauthorized users who download the software before passing the diskette along to others; the second technique is that a single authorized copy is obtained and production level copies are made and are sold to often unsuspecting users.

In either case, the very nature of the modern software distribution chain is partly to blame. Software programs are easily copied onto other medium or are easily distributed over the Internet.

While some upper level complex programs make it possible to go through a formal licensing and monitoring procedure, the vast majority of software programs do not have either the economic background nor the face-to-face relationship to justify the costs and economic burden in creating either a formal licensing or the monitoring that is required to prevent pirating of the software.

It is clear there is a need for an effective method to curtail the unauthorized copying of software.

### SUMMARY OF THE INVENTION

The invention is a software distribution system which uses a removable medium for distribution of the software programs. In this context, a removable medium includes any of a variety of mechanisms well known to those of ordinary skill in the art, including, but not limited to: Compact Discs (CDs); floppy discs; and magnetic cards.

In the preferred embodiment, a primary software program and a secondary software program are used. For purposes of example only, the primary software program is the software that is to be used, such as a word processor or a spread sheet. The primary software program is to be downloaded from the storage medium (such as a CD) onto the memory within the computer. Often, the copy of the software stored on the memory of the computer is used in the operation of the primary software; but, in some embodiments, the copy found on the medium (i.e. the CD) is used by the computer in operation.

Within the preferred embodiment, the secondary software program is used to establish an identifier. In operation, often, but not always, the secondary software is downloaded onto the memory of the computer and is run from there. The secondary software establishes an identifier which, in the preferred embodiment, incorporates an identification of the computer as well as the primary software. This is ideally done by combining the serial number from both the computer and the primary software either as a single run-on combination or as two components.

Once the secondary software has created the identifier, the secondary software program then erases itself. This action, erasing the secondary software, assures that a second “key” cannot be made. Hence, should a purchaser of the software want to share the primary software with someone else, the secondary software no longer exists and therefore a second key cannot be made.

This identifier (or key) is used by the primary software program to assure it is running on the proper computer; if the identifier is not found, the primary software program terminates. Ideally the routine of checking for the identifier is done at several places within the primary software program to assure that the program has not be modified (i.e. the front of the program removed) to escape from the “key” identification component of the primary software program.

In alternative embodiments, the identifier is established using a downloaded secondary software program or by a download of the identifier from the manufacturer. This latter embodiment is ideally used for an Internet type of distribution system. In this context, the user purchases a copy of the primary software and during the download of the primary software program, a “key”/identifier is placed onto the user's computer.

Again, when the primary software is operating, it checks to see if the identifier or key exists and terminates should the identifier or key be absent.

In some embodiments, the identifier is stored on a removable medium, thereby forming a physical “key” which must be used when the primary software is to be operated. In this embodiment, the key is stored on a medium such as a magnetic card well known to those of ordinary skill in the art. Again, as the program operates, it checks for the identifier on the magnetic card and terminates operation if the identifier or the key does is not found.

This embodiment is also useful where the owner wants to assure that no one is using the computer without authorization. By simply removing the magnetic card (key), the programs within the computer using the key are rendered inoperative.

In one embodiment of the invention. The medium used to distribute the software combination is an combination of both Write Once Read Many (WORM) and a Compact Disk Read Write (CDRW). This provides a non-erasable section (WORM) for the primary software program (thereby protecting the software for later loading onto the computer); as well as an erasable section (CDRW) for the secondary software program (allowing the secondary program to be erased once it has been used to establish the identifier).

The invention, together with various embodiments thereof, will be more fully explained by the accompanying drawings and the associated descriptions thereof.

### DRAWINGS IN BRIEF

FIG. 1 pictorially illustrates the preferred embodiment which uses two mediums with the computer.

FIG. 2 illustrates an embodiment of the medium used to communicate the primary software program and the secondary software program.

FIG. 3 is a block diagram of the a computer used in the present invention.

FIG. 4 is a flow-chart of the download from the medium into the computer.

FIG. 5 is a flow-chart of the preferred operation of the secondary software program.

FIG. 6 is a flow-chart of a subroutine used in the primary software program.

### DRAWINGS IN DETAIL

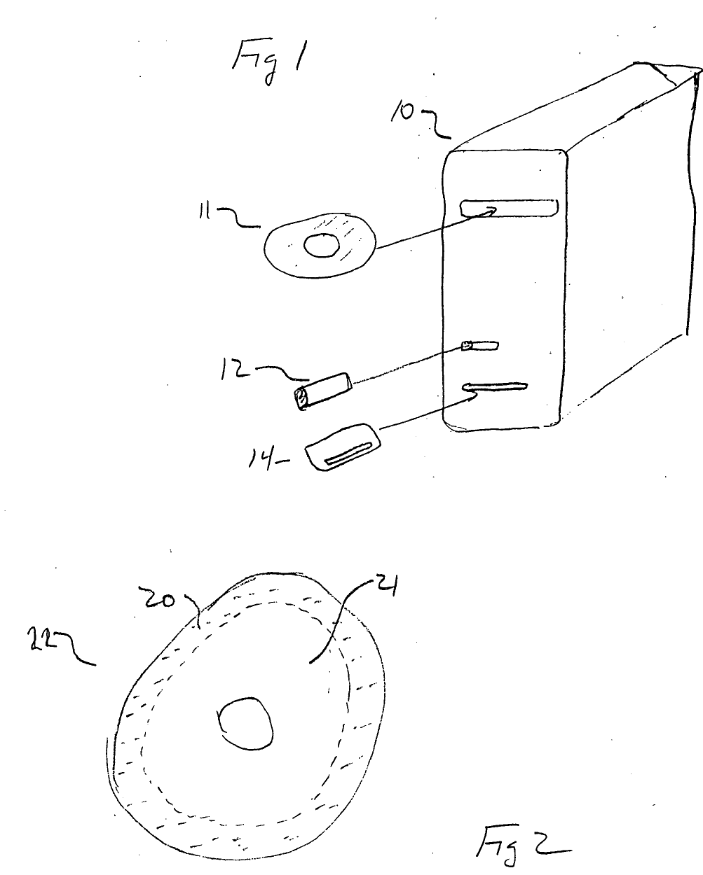

FIG. 1 pictorially illustrates the preferred embodiment which uses two mediums with the computer.

In this embodiment of the invention, computer 10 is adapted to receive a first medium 11 as well as a magnetic card 12. First medium 11 in this illustration is a CDRW which allows the primary software as well as the secondary software programs to be stored thereon.

Magnetic card 12 is used in the preferred embodiment, although any other erasable medium is also useable in this context (such as credit card 14). Other types of mediums which serve the purpose of the magnetic card 12 include, but are not limited to: CDRWs and floppy diskettes.

In the preferred embodiment, magnetic card 12 is used to hold the identifier used by the primary program and as such serves as a key. Note, in this manner, the two mediums are used in concert to obtain a working primary program. The user is able to move the primary software program to a second (or third, fourth, etc.) computer and have the primary software (such as a spread sheet) operate so long as the magnetic card 12 (“key”) is also used.

This feature also assures the user on the privacy of the primary software as the magnetic card 12, working as a key, provides an absolute barrier to unauthorized use of the software as the user is able to maintain physical control of the key; this eliminates the risky use of passwords and ID's for security.

FIG. 2 illustrates an embodiment of the medium used to communicate the primary software program and the secondary software program.

In some situations, the use of a CDRW is not adviseable as the primary software may be “lost” or corrupted. In this type of situation, a compact disk 22 is segmented into two different sections: a CDRW section 20, and, a WORM section 21. These two section form an erasable section (CDRW 20) and a non-erasable section (WORM 21). This allows the secondary software program to be stored on the erasable section 20; and, the primary software program to be stored on the non-erasable section 21.

As outlined above, once the secondary software program has created the identifier/key, the program is erased from the erasable section 20; but, the primary software, stored on the non-erasable section 21, remains intact and can be used to recreate the primary software on the computer should the copy within the computer become corrupted.

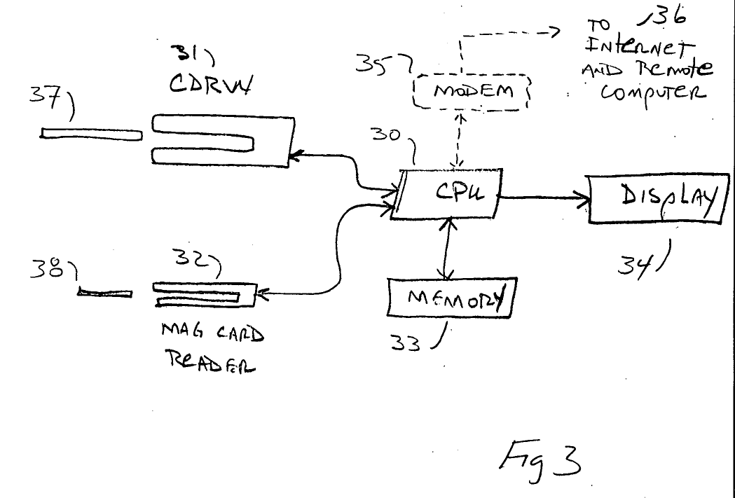

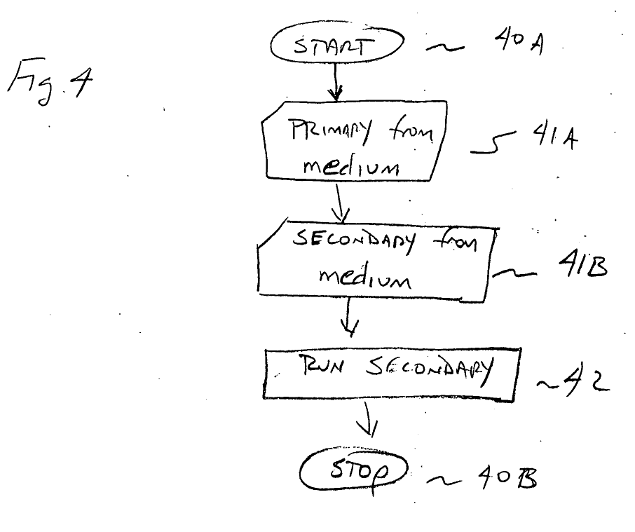

FIG. 3 is a block diagram of the a computer used in the present invention.

While those of ordinary skill in the art readily recognize a variety of computer systems which will serve in this function, the block diagram of FIG. 3 illustrates some of the major components and the considerations which are useful in creating such a computer.

At the heart of the computer is the Central Processing Unit (CPU) 30. A CDRW drive 31 is used to read the first medium 37. This information is stored by CPU 30 onto memory 33 which works as a non-volatile memory of data. CPU 30 operates under software programs and as such is the “brains” when operating under both the primary software program and the secondary software program.

Magnetic card reader 32 is able to read/write onto magnetic card 38 as per the directions of CPU 30.

In some embodiments, the identifier as established by the secondary program, as discussed above, is stored in both memory 33 and magnetic card 38 by the secondary program. In other embodiments, the identifier is stored only on magnetic card 38 and is also resident in the primary software program.

The secondary program is read from CDRW 37 via CDRW reader 31 and stored in memory 33 in the preferred embodiment. In an alternative embodiment, the secondary software program is obtained from a remote computer via the Internet 36 using modem 35 or such other communications device. In yet another embodiment, a secondary software program is not used, rather, the identifier is obtained from a remote computer on the Internet 36 again using modem 35.

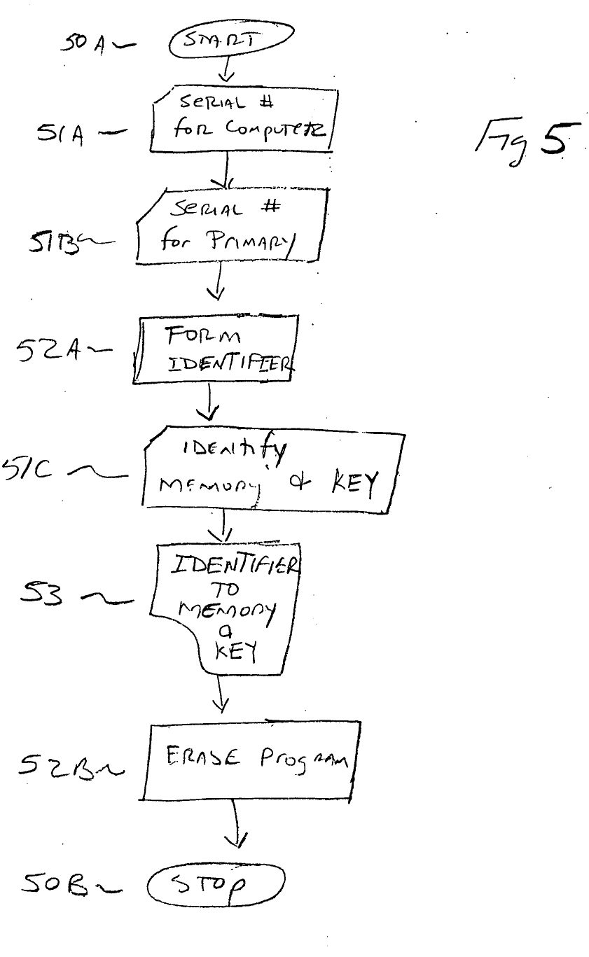

FIG. 4 is a flow-chart of the download from the medium into the computer. In this context, “download” is the reading of a program or data from one source and forming a copy of the program or data onto another medium or computer memory.

Once the download starts 40A, the primary software program is obtained from the medium 41A and is stored into the memory of the computer. In this context, using the example of FIG. 3, the primary software program is initially stored on CDRW 31.

The secondary software program is then downloaded 41B and is stored into the memory of the computer. The secondary software program is run 42 to establish the key or identifier within the appropriate locations and the copies of the secondary software program are erased; the programs stops 40B. At this point, the authorized user is able to run the primary program and the distributor of the primary software program is assured that only a single authorized copy of the software may be used.

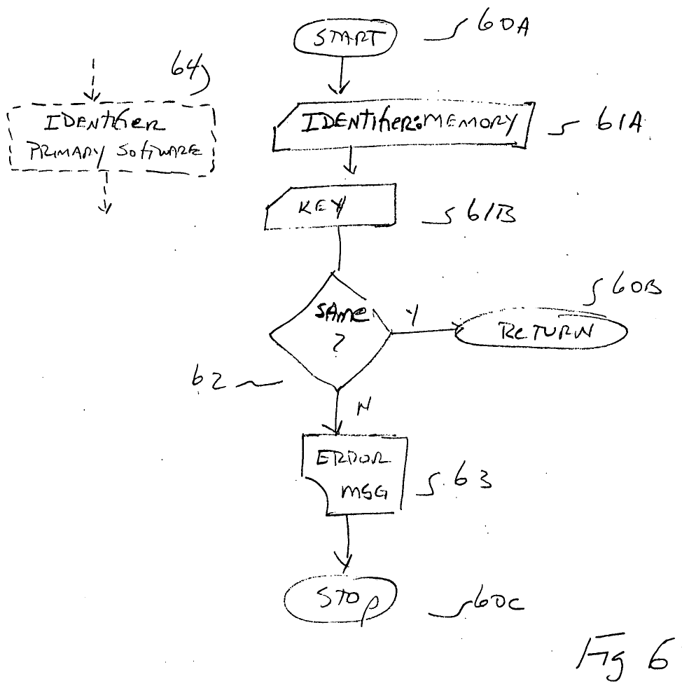

FIG. 5 is a flow-chart of the preferred operation of the secondary software program.

As noted above, the secondary software program is used to establish the “key” or identifier which is used by the primary software program. In the preferred embodiment, the program starts 50A and withdraws a serial number for the computer 51 on which the program is operating 51A. While the preferred embodiment uses the serial number, the invention is not so limited as any identifier is useable, including, but not limited to a random number generated by the secondary software program. In the preferred embodiment, the identifier is unique to the computer and primary software program copy.

The next step is to obtain the serial number for the primary software program 51B. Using the two serial numbers, an identifier is formed 52A In this embodiment, the identifier is then stored on both the computer's internal memory as well as any “key” mechanism (such as a magnetic card or floppy diskette). The program then determines which memory and key is to be used for storage of the identifier 51C and the identifier is stored to the appropriate locations 53.

This sequence of steps allows the secondary software program to establish the key at the appropriate locations to comply with the structure of the actual computer being used. As example, some computers do not have the ability to read magnetic cards, but, they may have a floppy diskette drive, hence the floppy diskette becomes the key.

The secondary software program then erases its own copies from the non-volatile memory of the computer as well as from the medium upon which it was transferred (i.e. the CDRW discussed above) and the secondary software program stops 50B. Since the secondary software program is operating from volatile memory, when the operating copy of the secondary software terminates (50B), all copies of the secondary software program have been destroyed, thereby preventing the user from creating an unauthorized key.

FIG. 6 is a flow-chart of a subroutine used in the primary software program.

This subroutine is embedded into the primary software program and is run periodically from the primary software program. The purpose of this subroutine is to assure the primary software program that it is operating on an authorized machine with authorized software.

Once the subroutine begins, it reads the identifier from the memory 61A of the computer. This identifier is stored in a location and is used to “mark” the computer itself.

In some embodiments, the identifier is not stored on the computer but is embedded as a data component within the primary software computer. In this embodiment, the identifier is simply used from the primary software data grouping 64 instead of reading the identifier from memory 61A. This embodiment allows the primary software program to be used on any computer provided the key is also present.

In either case, the identifier is then read from the key (such as the magnetic card) 61B.

The two read identifiers are then compared 62.

Note, in this embodiment, if either the computer memory or the magnetic card do not contain an identifier, then the comparison 62 yields a NO; also if the two identifiers are not identical, then a NO at comparison 62 is generated. In this case (NO), an error message is given to the user 63 and the primary software program stops 60C.

If the comparison 62 yields a YES, then the subroutine returns 60B to the primary software programs task.

In this manner, the primary software program only operates on the proper computer having the appropriate key.

It is clear that the present invention provides for an effective method to curtail the unauthorized copying of software.

What is claimed is:

1. A system comprising:
a) a first removable medium having stored thereon a primary software program; and,
b) a computer having means for,
1) downloading said primary software program from said first removable medium to a memory within said computer, and,
2) operating said primary software program; and,
wherein during operation of said primary software program by said computer, operation of said primary software program terminates if said computer is unable to read a first identifier, said first identifier being separate from said primary software program.

2. The system according to claim 1,
a) wherein said first removable medium includes a secondary software program; and,
b) wherein said computer includes means for,
1) downloading said secondary software program to the memory of said computer from said first removable medium,
2) operating said secondary program to,
A) establish said first identifier, and,
B) erase said secondary program from said first removable medium and said memory within said computer.

3. The system according to claim 2, further including a second removable medium and wherein said first identifier is stored thereon.

4. The system according to claim 3,
a) wherein during operation of said secondary software program by said computer, said secondary software program establishes a second identifier in a non-volatile memory of said computer; and,
b) wherein operation of said primary software program by said computer is terminated if said computer is unable to read said second identifier.

5. The system according to claim 4, wherein said first identifier and said second identifier uniquely identify said computer and said primary software program.

6. The system according to claim 5, wherein said first identifier and said second identifier are identical.

7. The system according to claim 2, wherein said first removable medium includes:
a) a first section having non-erasable memory; and,
b) a second section having erasable memory.

8. The system according to claim 7,
a) wherein said primary software program is stored in said first section of said first removable medium; and,
b) wherein said secondary software program is stored in the second section of said first removable medium.

9. The system according to claim 1, wherein said computer includes means for:
a) accepting said first identifier from a remote computer; and,
b) storing said first identifier in the memory of said computer.

10. The system according to claim 9, further including a second removable medium and wherein a second identifier is stored therein.

11. The system according to claim 10, wherein operation of said primary software program by said computer is terminated if said computer is unable to read said second identifier.

12. The system according to claim 11, wherein said first identifier and said second identifier uniquely identify said computer and said primary software program.

13. The system according to claim 1, wherein said computer includes means for:
a) downloading a secondary software program to the memory of said computer; and
b) operating said secondary program to,
1) establish said first identifier, and,
2) erase said secondary program from said memory within said computer.

14. The system according to claim 13, further including a second removable medium and wherein said first identifier is stored thereon.

15. The system according to claim 14,
a) wherein during operation of said secondary software program by said computer, said secondary software program establishes a second identifier in a non-volatile memory of said computer; and,
b) wherein operation of said primary software program by said computer is terminated if said computer is unable to read said second identifier.

16. The system according to claim 15, wherein said first identifier and said second identifier uniquely identify said computer and said primary software program.

17. A software verification system comprising a primary software program which, during operation, terminates if a computer upon which the primary software program is operating is unable to read a first identifier.

18. The software verification system according to claim 17,
a) further including a first removable medium having a secondary software program stored thereon; and,
b) wherein said computer includes means for,
1) downloading said secondary program to the memory of said computer from said first removable medium, and,
2) operating said secondary program to,
A) establish said first identifier, and,
B) erase said secondary program from said first removable medium and said memory within said computer.

19. The software verification system according to claim 18, further including a second removable medium and wherein said first identifier is stored thereon.

20. The software verification system according to claim 19,
a) wherein during operation of said secondary software program by said computer, said secondary software program establishes a second identifier in a non-volatile memory of said computer; and,
b) wherein operation of said primary software program by said computer is terminated if said computer is unable to read said second identifier.

21. A software distribution system comprising:
a) a first removable medium having stored thereon a primary software program and a secondary software program; and,
b) a computer having means for,
1) downloading said primary software program and said secondary software program from said first removable medium to a memory within said computer,
2) operating said secondary software program to,
A) establish a first identifier, and,
B) erase said secondary software program from said first removable medium and the memory of said computer; and,
wherein during operation of said primary software program by said computer, operation of said primary software program terminates if said computer is unable to read the first identifier.

22. The software distribution system according to claim 21, further including a second removable medium and wherein said first identifier is stored thereon.

23. The software distribution system according to claim 22,
a) wherein during operation of said secondary software program by said computer, said secondary software program establishes a second identifier in a non-volatile memory of said computer; and,
b) wherein operation of said primary software program by said computer is terminated if said computer is unable to read said second identifier.
